(19) United States
(12) Patent Application Publication
(10) Pub. No.: US 2024/0269877 A1
(43) Pub. Date: Aug. 15, 2024

(54) APPLE SLICER

(71) Applicant: Lifetime Brands, Inc., Garden City, NY (US)

(72) Inventors: Matthew Krus, Seattle, WA (US); Ian Morgan, Seattle, WA (US); Samantha Piercy, Edmonds, WA (US)

(21) Appl. No.: 18/166,777

(22) Filed: Feb. 9, 2023

(51) Int. Cl. B26D 3/26; A47J 25/00

(52) U.S. Cl. CPC B26D 3/26; A47J 25/00

(57) ABSTRACT

An apple slicer includes a base having an inner surface, a solid central portion and a plurality of blades radially extending from the solid central portion to the inner surface and a gripping portion integrally formed with the base. The solid central portion is generally circular and non-removable. The solid central portion passes freely through a coreless apple, while the plurality of blades slice through the coreless apple.

### FIELD OF INVENTION

The present invention relates generally to kitchen cutting and slicing utensils, and more specifically, to an apple slicer.

### BACKGROUND

Devices for cutting apples into sections have been available for many years. In a typical device, several radial blades are supported by a central hub blade and an outer frame. As the device is pushed downward over an apple, the central hub blade cuts the core into a central cylinder while the radial blades divide the remaining apple into several wedge-shaped sections.

Unfortunately, current devices can be difficult to use because they do not readily push all the way through an apple or other food item. The core of the apple, for example, may provide resistance against a clean cut. This leads to users pushing against the final bit of apple with their fingers, risking a cut or injury as the fingers come into contact with one or more blades.

### SUMMARY

In accordance with an embodiment, an apple slicer is provided. The apple slicer includes a base having an inner surface, a solid central portion and a plurality of blades radially extending from the solid central portion to the inner surface and a gripping portion integrally formed with the base.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a perspective view of an apple slicer and an apple corer, in accordance with an embodiment of the present invention;

FIG. 2 is a perspective view of the apple corer combined with the apple slicer when not in use, for storage purposes, in accordance with an embodiment of the present invention;

FIG. 3 is a perspective bottom view of the apple slicer, in accordance with an embodiment of the present invention;

FIG. 4 is a perspective view of the apple corer being inserted into an apple, in accordance with an embodiment of the present invention;

FIG. 5 is a perspective view of the apple corer removing the core of the apple, in accordance with an embodiment of the present invention;

FIG. 6 is a perspective view of the apple slicer being applied over the coreless apple, in accordance with an embodiment of the present invention; and

FIG. 7 is a perspective view of the apple slicer slicing the coreless apple into multiple wedge pieces, in accordance with an embodiment of the present invention.

Throughout the drawings, same or similar reference numerals represent the same or similar elements.

### DETAILED DESCRIPTION

Embodiments in accordance with the present invention provide for an apple slicer. The apple slicer includes a base having an interior surface, a solid central portion, and a plurality of blades extending from the solid central portion to the inner surface. The solid central portion is generally circular and is fixedly secured or non-removable in relation to the apple slicer. The solid central portion passes freely through a coreless apple, while the plurality of blades slice through the same.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

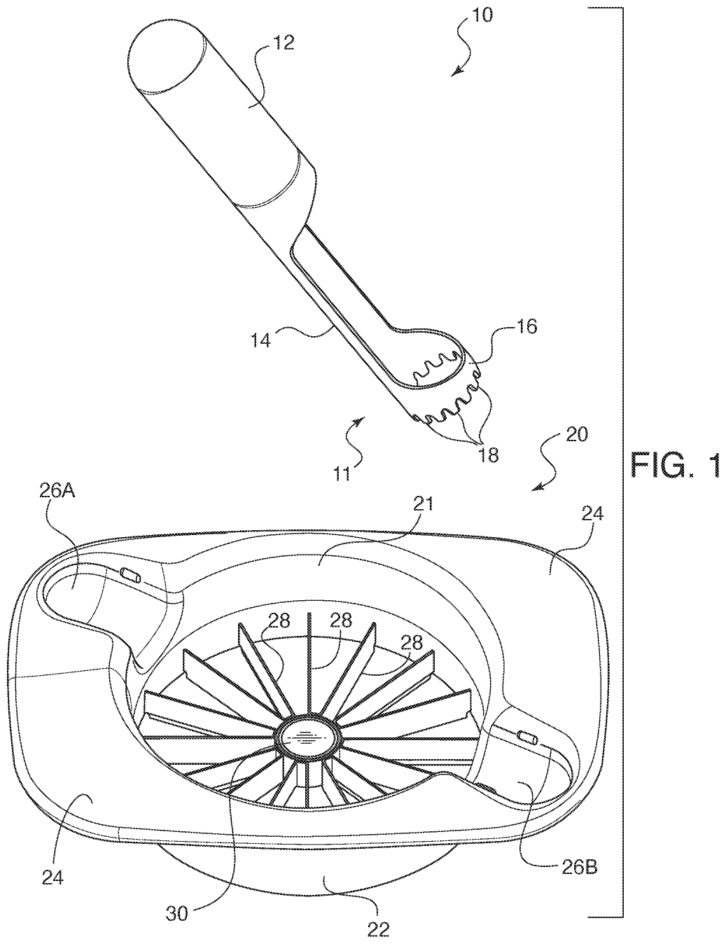

FIG. 1 is a perspective view of an apple slicer and an apple corer, in accordance with an embodiment of the present invention. The apple corer 10 includes a handle 12 with a cutting tube 14 attached thereto. The distal end 11 of the apple corer 10 includes a head 16 with serrated teeth 18 extending from the cutting tube 14. The serrated teeth 18 can be positioned circumferentially around the head 16. The topmost portion of the cutting tube 14 is completely enclosed, whereas the middle and bottom portions of the cutting tube 14 are not completely enclosed. The opening of the cutting tube 14 allows for the easy removal of the apple core.

The apple slicer 20 includes a base 22 and gripping portion(s) 24 integrally formed with the base 22. The base 22 defines an outer surface and an inner surface 21. The base 22 can accommodate a plurality of blades 28. The plurality of blades 28 are formed in a radial configuration such that one end of all the plurality of blades 28 directly contacts or is connected with a central solid body portion 30. The central solid body portion 30 can also be referred to as a solid central portion.

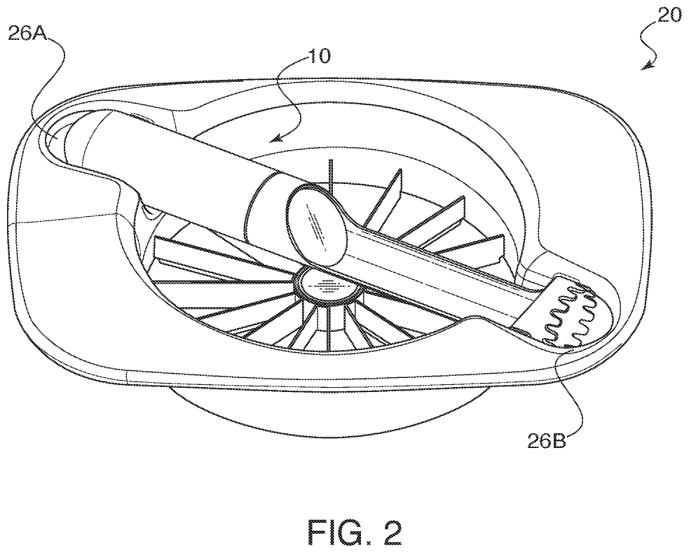

According to one embodiment, the gripping portions 24 further define a first recess 26A and a second recess 26B. The first recess 26A and the second recess 26B are diametrically opposed to each other. Stated differently, the first recess 26A and the second recess 26B are formed or disposed in a diagonal manner on the gripping portions 24. The first recess 26A and the second recess 26B are configured to receive opposed ends of the apple corer 10 (FIG. 2) for storage purposes. An apple is configured to be sliced by the plurality of blades 28, as further discussed below.

FIG. 2 is a perspective view of the apple corer combined with the apple slicer when not in use, for storage purposes, in accordance with an embodiment of the present invention.

The apple corer 10 can be combined with the apple slicer 20 for storage purposes. Parts of the apple corer 10 can be maintained within the first and second recesses 26A, 26B, respectively, defined by the gripping portions 24. In particular, the handle 12 can be placed within the recess 26A and the head 16 can be placed within the recess 26B such that the cutting tube 14 can extend over the plurality of blades 28. In fact, a portion of the handle 12 can also extend over the plurality of blades 28. A topmost portion of the cutting tube 14 can be vertically aligned with the central solid body portion 30. Therefore, the apple corer 10 is positioned or placed or disposed on the apple slicer 20 for storage purposes. The apple corer 10 can be disposed or placed or positioned diagonally over the apple slicer 20 for storage purposes. Stated differently, the apple corer 10 can be removably attached to or removably engaged to the apple slicer 20. A majority of the apple corer 10 can extend over the plurality of blades 28 disposed within the base 22 of the apple slicer 20.

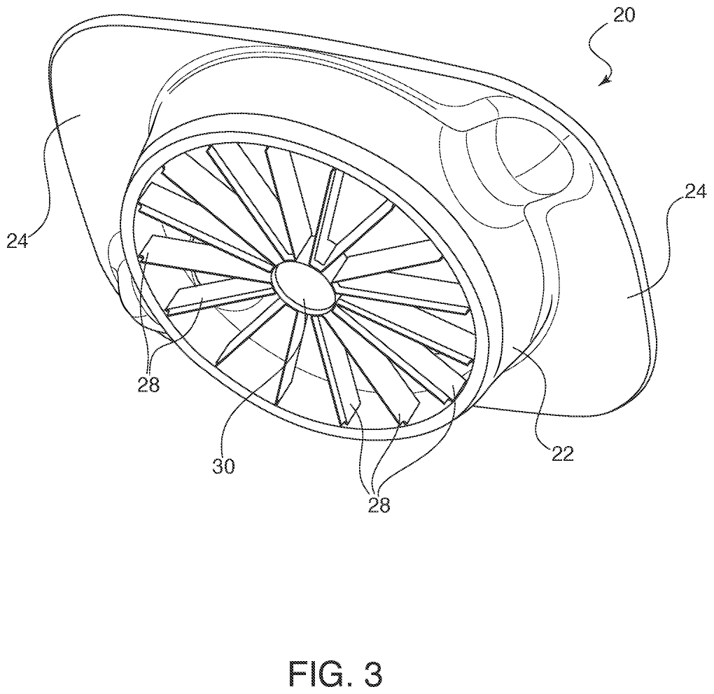

FIG. 3 is a perspective bottom view of the apple slicer 20, in accordance with an embodiment of the present invention. The bottom view shows the plurality of blades 28 accommodated within the base 22 of the apple slicer 20. Additionally, the central solid body portion 30 is better shown. The central solid body portion 30 does not allow any portions of an apple being sliced to be passed therethrough. The central solid body portion 30 is not a central hub blade. In fact, the central solid body portion 30 includes no blades. Instead, the central solid body portion 30 is a solid circular piece without any blades or blade elements. The central solid body portion 30 is fixedly secured or a non-removable component or element.

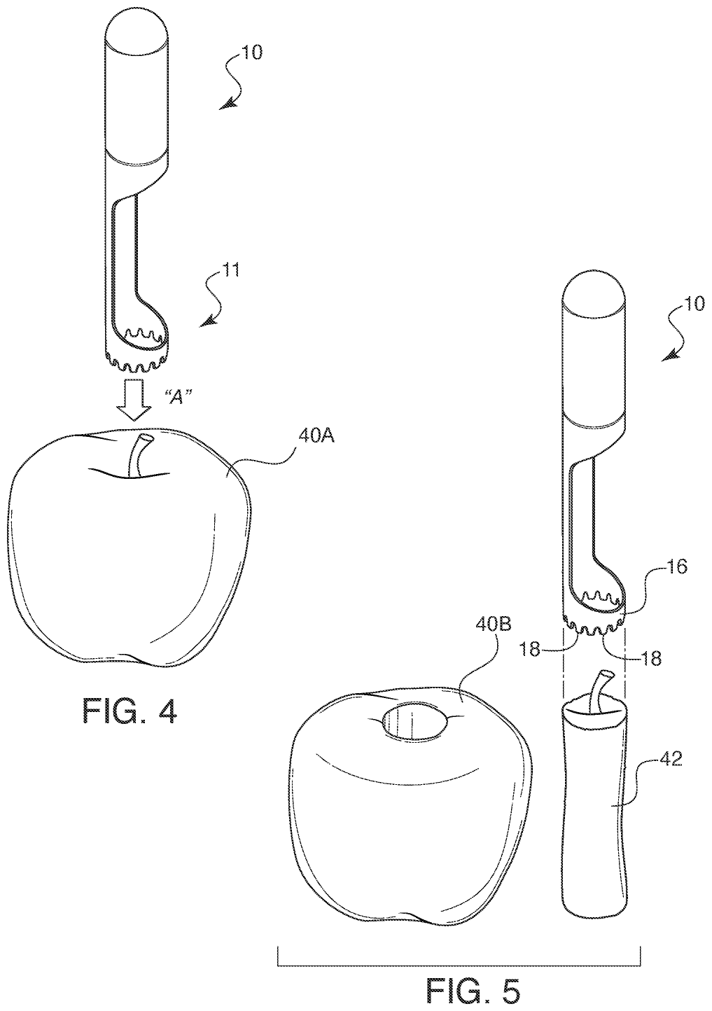

FIG. 4 is a perspective view of the apple corer 10 being inserted into an apple, in accordance with an embodiment of the present invention. In use, the apple 40A is cored by inserting the apple corer 10 into the core of the apple. The apple corer 10 is applied in direction “A” such that the distal end 11 enters the core portion of the apple 40A.

FIG. 5 is a perspective view showing the apple corer 10 removing the core 42 of the apple 40A, in accordance with an embodiment of the present invention. In use, the apple corer 10 has removed the core 42 of the apple 40A such that a coreless apple 40B remains. The serrated teeth 18 of the head 16 allow for the removal of the core 42 of the apple 40A.

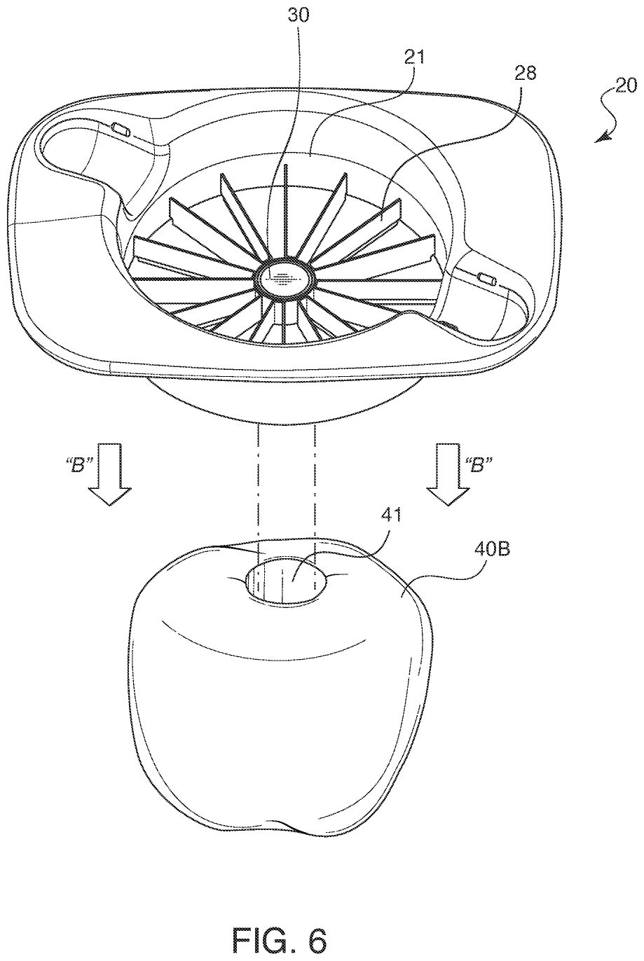

FIG. 6 is a perspective view of the apple slicer 20 being applied over the coreless apple 40B, in accordance with an embodiment of the present invention. After removal of the core 42 of the apple 40A, the coreless apple 40B is ready to be sliced by the apple slicer 20. The apple slicer 20 is positioned over the coreless apple 40B and the apple slicer 20 is applied in a direction “B.” The central solid body portion 30 is aligned with a hole 41 in the coreless apple 40B such that the central solid body portion 30 passes freely through the coreless apple 40B, while the plurality of blades 28 slice through the same. Thus, the core 42 does not provide any resistance to the apple slicer 20 as it has been removed before slicing the apple.

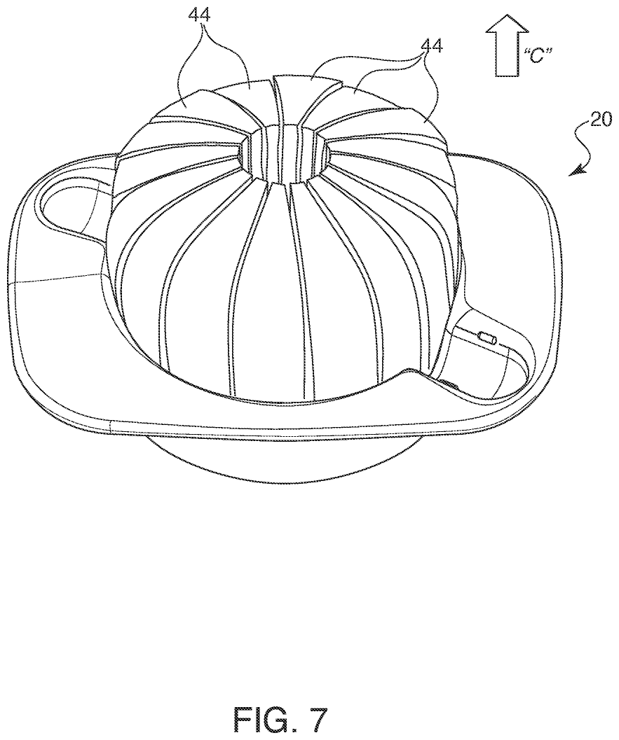

FIG. 7 is a perspective view of the apple slicer 20 slicing the coreless apple 40B into multiple wedge pieces 44, in accordance with an embodiment of the present invention. In use, the apple slicer 20 is pushed over the coreless apple 40B such that the coreless apple 40B slowly advances through the apple slicer 20 in a direction “C” (as the apple slicer 20 is pushed over the coreless apple 40B), and apple slices or apple wedges 44 are obtained.

Therefore, in accordance with FIGS. 4-7, a user can first remove the core 42 of the apple 40A with the apple corer 10 and then slice the remaining apple (coreless apple 40B) with the apple slicer 20 to obtain apple wedges 44. The user can then wash the apple corer 10 and the apple slicer 20, and integrate or combine the two components for storage purposes.

In summary, the exemplary embodiments present an apple slicer including a base having an interior surface, a solid central portion, and a plurality of blades extending from the solid central portion to the inner surface. The solid central portion is generally circular and is fixedly secured or non-removable in relation to the apple slicer. The solid central portion passes freely through a coreless apple, while the plurality of blades slice through the same.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, parameters, thresholds, and other elements used herein are provided as examples, and can be given a different name or label. The use of the term “or” is not limited to exclusive “or” but can also mean “and/or”.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

1. An apple slicer comprising:
a base having an inner surface, a solid central portion and a plurality of blades radially extending from the solid central portion to the inner surface; and
a gripping portion integrally formed with the base.

2. The apple slicer of claim 1, wherein the solid central portion is generally circular.

3. The apple slicer of claim 1, wherein the solid central portion is non-removable.

4. The apple slicer of claim 1, wherein the solid central portion passes freely through a coreless apple, while the plurality of blades slice through the coreless apple.

5. The apple slicer of claim 1, wherein the gripping portion has recesses on opposed ends thereof.

6. The apple slicer of claim 1, wherein the recesses are configured to accommodate an apple corer.

7. The apple slicer of claim 6, wherein the apple corer is placed diagonally in relation to the apple slicer.
